(19) United States
(12) Patent Application Publication
(10) Pub. No.: US 2007/0255740 A1
(43) Pub. Date: Nov. 1, 2007

(54) Persistent announcement channel for personal internet communicator

(75) Inventor: Jeffrey M. Lavin, Longmont, CO (US)

Correspondence Address: HAMILTON & TERRILE. LLP, P.O. BOX 203518, AUSTIN, TX, 78720, US

(73) Assignee: Advanced Micro Devices, Inc.

(21) Appl. No.: 11/740,494

(22) Filed: Apr. 26, 2007

Related U.S. Application Data
(60) Provisional application No. 60/795,233, filed on Apr. 26, 2006.

(51) Int. Cl. G06F 7/00

(52) U.S. Cl. 707/101

(57) ABSTRACT

A system, method and business method to provide a persistent announcement channel for the verified conveyance of predetermined digital content over a communications network, such as the Internet. Predetermined digital content is retrieved from a plurality of digital content providers. Once retrieved, the digital content is conveyed to a secure computing environment implemented on a personal Internet communicator (PIC) provided by an Internet service provider (ISP) or other entity. Commonly-used graphic file formats are implemented to persistently present predetermined digital content within a dedicated area of the PIC display screen. The frequency and duration of the displayed digital content is a result of predetermined content file attributes. A feedback channel provides content providers verification that a predetermined user has interacted with the conveyed digital content.

### CROSS-REFERENCE TO RELATED APPLICATION

This application claims the benefit under 35 U.S.C. § 119(e) of U.S. Provisional Application No. 60/795,233, filed Apr. 26, 2006, entitled “Persistent Announcement Channel for Personal Internet Communicator,” which is incorporated by reference in its entirety.

### BACKGROUND OF THE INVENTION

1. Field of the Invention

The present invention relates to the field of information processing systems and, more particularly, to a system, method, and business method for verifying the conveyance of digital content over a network.

2. Description of the Related Art

Computer systems have attained widespread use by many segments of today's society for managing a wide variety of information. A personal computer system can usually be defined as a microcomputer that includes a system unit having a system processor and associated volatile and non-volatile memory, a display monitor, a keyboard, a fixed disk storage device, an optional removable storage device and an optional printer. These personal computer systems are information processing systems which are designed primarily to give independent computing power to a single user (or a group of users in the case of personal computers which serve as computer server systems) and are inexpensively priced for purchase by individuals or small businesses.

In recent years, there has been significant growth in the use of the personal computers to exchange information over the Internet. This exchange of information is based on a client/server model with the user's personal computer operating as the client to access data stored on a plurality of Internet servers. These general purpose computers are typically implemented with a sophisticated operating system that is capable of supporting a broad range of software programs, full-capability communications with the Internet, and a extensive variety of peripherals. However, such full-featured computers may be beyond the financial means of some segments of the world's population. In other cases, potential users may not possess the skill or knowledge to operate typical, general purpose computer systems. As such, it is desirable to provide a personal Internet communicator (PIC) device, possessing simple and reliable computing, communications and information access capabilities to a larger segment of the world's population.

Some Internet service providers (ISPs) provide such a device to these population segments as part of a contractual relationship to provide Internet service. Other entities, such as government agencies, provide similar arrangements. As part of the relationship, the ISP or other entity may occasionally need to deliver authorized software upgrade packages, software packages that provide additional capabilities, and/or viewable content. These include, but not limited to, educational information, public service announcements, or advertising, which can assist in offsetting the costs of providing PICs to underserved population segments. However, users may also attempt to view and/or download other content from the Internet or to install software programs that may not be authorized or secure. These downloads may adversely affect the operation of the computer and/or interfere with the delivery of authorized digital content. It would be advantageous to provide a secure computing environment for the monitored and verified distribution, receipt, and consumption of authorized digital content over a communication network and through a PIC device, but no such ability currently exists.

### SUMMARY OF THE INVENTION

The system, method and business method of the present invention provides a persistent announcement channel for the verified conveyance of predetermined digital content over a communications network, such as the Internet. In various embodiments of the invention, predetermined digital content is retrieved from a plurality of digital content providers. Once retrieved, the digital content is conveyed over a communication network to a secure computing environment implemented on a personal Internet communicator (PIC). As commonly implemented, a PIC is a simple, low cost computing, communications and information access device provided by an Internet service provider (ISP) or other entity. A PIC typically comprises a microcomputer that includes a system unit having a system processor and associated volatile and non-volatile memory, a display monitor, a keyboard, a fixed disk storage device, an optional removable storage device and an optional printer. In general, the PIC is suitable for distribution and operation within the economic and infrastructure constraints generally encountered in underdeveloped countries. In different embodiments of the invention, predetermined digital content is persistently presented through the display via the operating system implemented on the PIC without requiring the implementation of a Web browser. In different embodiments of the invention, the predetermined digital content is displayed using commonly implemented graphic file formats, including but not limited to, HTML, JPEG, MPEG, AVI, WMF, Quicktime provide by Apple Computer, Inc. and Flash and Shockwave, provided by Macromedia, Inc.

The source of predetermined digital content includes, but is not limited to, government entities providing law enforcement, health, weather, and other public services, as well as ISPs providing a conduit for the delivery of advertising content. The frequency with which such predetermined digital content is displayed is based on predetermined attributes that are associated with the content at its time of distribution. For example, a banner message displaying the name of the ISP or government entity underwriting the cost of the PIC could be presented every time the PIC is booted. As another example, a law enforcement agency or severe weather announcement may be displayed once every ten minutes until it is superseded by a subsequent announcement, is cancelled by the issuing entity, or expires after a predetermined time interval. As yet another example, a health advisory notice may have attributes requiring its display once a day for five days, or display once every four hours until the fifteenth of the month. As a further example of an embodiment of the invention, if the PIC is in off-line use, acknowledgement that a health alert has been received can be signified by user gesture resulting in the attributes of the content being altered such that the content is not automatically displayed again, but is available for subsequent retrieval, and the sender is notified that the alert has been acknowledged as being received when the PIC is next connected to the Internet. In one embodiment, a predetermined area of the PIC display is reserved for the persistent presentation of predetermined digital content, such as a banner area across the top of the screen. In another embodiment of the invention, predetermined digital content is displayed via the operating system implemented on the PIC through a pop-up window that overlays any currently running application, including but not limited to, a Web browser. Based on the attributes associated with the displayed content, the pop-up window stays open until a user gesture (e.g., mouse click, control key sequence, etc.) signifies that its receipt has been acknowledged.

The secure computing environment provided by the present invention is broadly comprised of a content provision and user interaction database that contains a list of predetermined digital content and software files. The secure computing environment also comprises a verification module that is operable to receive requests to load predetermined digital content or software files and to compare the requested content or software to the verified list of predetermined digital content or software files. Distributed digital content and software files have an associated identifier that is recognized by the verification module. If the verification module doesn't recognize the content or file identifier as being authorized, it is neither displayed nor executed. The verification module is securely updated through cryptographic methods known to those of skill in the art. In different embodiments of the invention, a pay state status monitor provides the operating system with information concerning the pay state status of the user, which determines the functionality of digital content and software files on a PIC device. The PIC is operable to provide limited functionality of certain software packages if based on a first pay state and to offer no functionality based on a second pay state. For example, PIC functionality can be reduced or discontinued if a user has discontinued his contractual relationship with an Internet service provider or is not complying with the requirements of a digital content conveyance policy. In one embodiment, the pay state works on a credit system. As predetermined digital content is signified by user gestures to acknowledge its presentation and subsequent interaction, pay state credits accumulate, granting the user the ability to view other digital content or use the PIC for other purposes. As the PIC is used for other purposes or for viewing other digital content, pay state credits deplete. If pay state credit depletes to a predetermined point, then interaction with other predetermined digital content is required before the user of the PIC 110 can continue.

### BRIEF DESCRIPTION OF THE DRAWINGS

FIG. 1 is a generalized block diagram of an exemplary network wherein a plurality of computer systems, such as, but not limited to personal Internet communicators (PICs), communicate over one or more communication networks;

FIG. 2 is a generalized block diagram of a PIC as implemented in accordance with an embodiment of the invention;

FIG. 3 is a generalized block diagram of a processor comprising a PIC as implemented in accordance with an embodiment of the invention;

FIG. 4 is a generalized block diagram of the functional components for implementing a persistent announcement channel through a verified computing environment of a PIC in accordance with an embodiment of the invention;

FIG. 5a is a generalized depiction of a persistent announcement delivery channel implemented as a dedicated area within a PIC display screen in accordance with an embodiment of the invention; and

FIG. 5b is a generalized depiction of a persistent announcement delivery channel implemented as a dynamic pop-up overlay window within a PIC display screen in accordance with an embodiment of the invention.

### DETAILED DESCRIPTION

The system, method and business method of the present invention provides a persistent announcement channel for the verified conveyance of predetermined digital content over a communications network, such as the Internet. In various embodiments of the invention, predetermined digital content is retrieved from a plurality of digital content providers. Once retrieved, the digital content is conveyed over a communication network to a secure computing environment implemented on a personal Internet communicator (PIC).

While illustrative embodiments of the present invention are described below, it will be appreciated that the present invention may be practiced without the specified details, and that numerous implementation-specific decisions may be made to the invention described herein to achieve the developer's specific goals, such as compliance with system-related and business-related constraints, which will vary from one implementation to another. While such a development effort might be complex and time-consuming, it would nevertheless be a routine undertaking for those of skill in the art having the benefit of this disclosure. For example, selected aspects are shown in block diagram form, rather than in detail, in order to avoid obscuring or unduly limiting the present invention. Such descriptions and representations are used by those skilled in the art to describe and convey the substance of their work to others skilled in the art. The present invention will now be described with reference to the drawings described below.

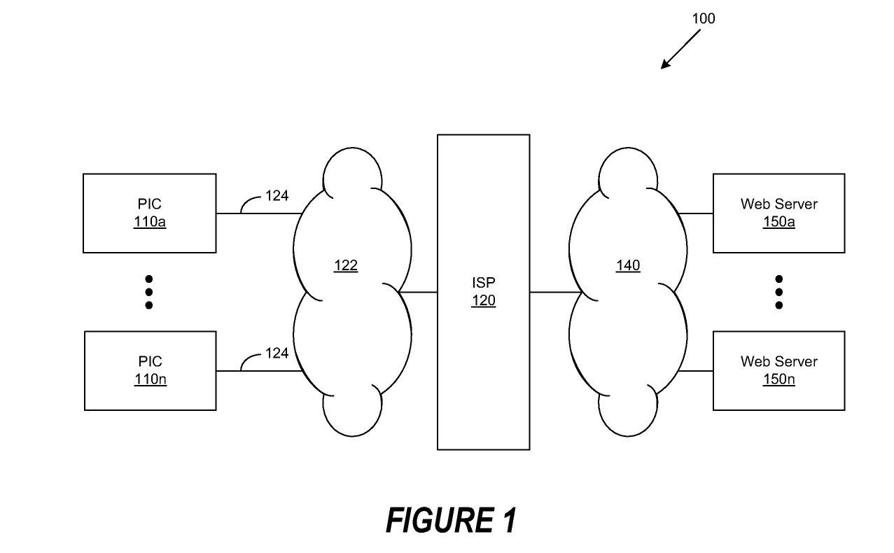

Referring to FIG. 1, a block diagram of an exemplary network 100 is shown wherein a plurality of computer systems 110a-n, such as, but not limited to personal Internet communicators (PICs), communicates over one or more ISP communication networks 122, 140. As illustrated, each computer system 110a-n is coupled to an Internet service provider (ISP) 120 via ISP communication network 122, which comprises one or more communication links 124. Internet service provider 120 is coupled to the Internet 140 that is further coupled to a plurality of Web host servers 150a-n. A user wishing to access information on the Internet uses a PIC (e.g., 110a-n) to execute an application program (e.g., a Web browser) stored on PIC 110a-n.

PIC 110a-n includes communication hardware and software that allows PIC 110a-n to send and receive communications to and from ISP 120 via a communications link 124. The communication link 124 may be any of a variety of connection types including a wired connection, a direct link such as a digital subscriber line (DSL), T1, integrated services digital network (ISDN), or cable connection, a wireless connection via a cellular or satellite network, phone modem dialup access, or a local data transport system, such as Ethernet or token ring over a local area network.

Requests for information are entered by a user into a Web browser or other application implemented on PIC 110a-n, which then sends the information request to Internet service provider 120. ISP 120, executing software for receiving and reading requests sent from the PIC 110a-n, forwards the information request to a predetermined Web host server 150a-n via the Internet 140. The predetermined Web host server 150a-n similarly executes a Web server application program that monitors and receives requests. Once received, the information are serviced by the Web server application program, resulting in the requested information being conveyed back to the user's PIC 110a-n.

Each Web host server 150a-n on the Internet has a known address that the user supplies to the Web browser to connect to a predetermined Web host server 150a-n. If the requested information is not available on the predetermined Web host server 150a-n, the Internet 140 serves as a central link that allows Web servers 150a-n to communicate with one another to supply the requested information. Because Web servers 150a-n can contain more than one Web page, the user will also specify in the address which particular Web page he wants to view. The address, also known as a universal resource locator (URL), of a home page on a server is a series of numbers that indicate the server and the location of the page on the server, analogous to a post office address. For simplicity, a domain name system was developed that allows users to specify servers and documents using names instead of numbers. A URL may further specify a particular page in a group of pages belonging to a content provider by including additional information at the end of a domain name.

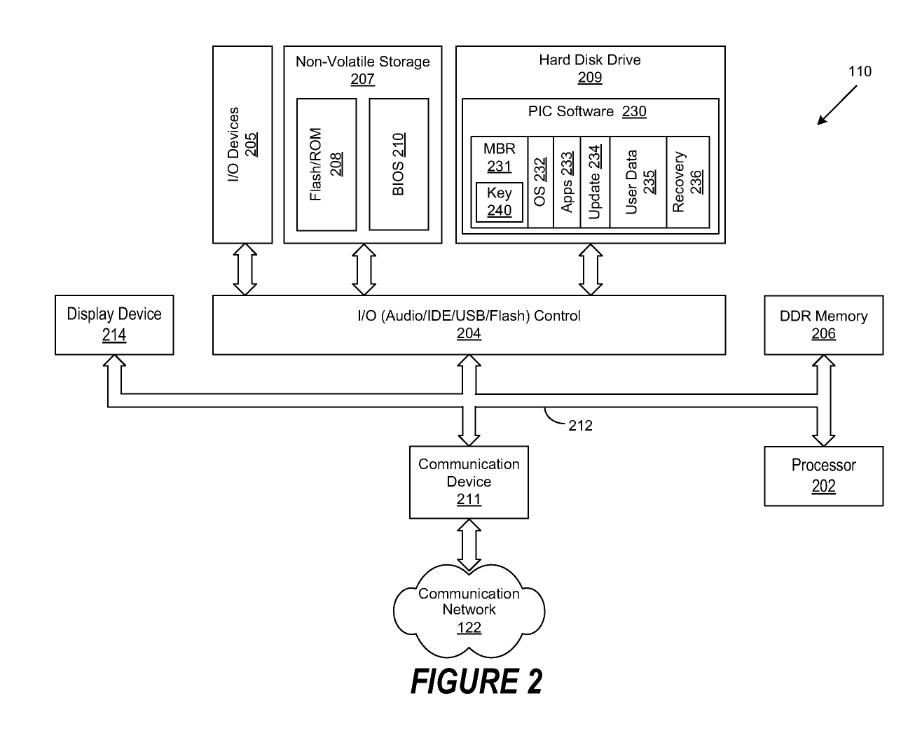

Referring to FIG. 2, a block diagram of PIC 110 is shown. PIC 110 includes a processor 202, input/output (I/O) control device 204, memory (including volatile random access memory (RAM) memory 206, non-volatile memory 207, and volatile memory comprising hard disk drive 209), communication device 211 (such as a modem) and a display 214. Processor 202, I/O controller 204, memory 206, 207, 209 and communication device 211 are interconnected via one or more buses 212. In an embodiment of the invention, processor 202 is implemented as an AMD Geode GX 32-bit x86 compatible processor, memory 206 is implemented as a 128 MB DDR memory and display 214 is implemented as a LCD monitor. In addition, non-volatile memory 207 may include Flash/read only memory (ROM) 208 and Basic Input/Output System (BIOS) 210. Either or both of memories 206, 207 may be integrated with or external to PIC 110. In one embodiment, communication device 211 comprises an integrated 56K ITU v. 92 Modem with an external connector which may be used to support different phone systems throughout the world, though other modems may also be used. Those of skill in the art will realize that other device configurations may also be used for processor 202, memory 206, 207, 209, display 214, and communication device 211. For clarity and ease of understanding, not all of the elements making up PIC 110 are described in detail. Such details are well known to those of skill in the art, and may vary based on the particular computer vendor and microprocessor type. Moreover, PIC 110 may include other buses, devices, and/or subsystems, depending on the implementation desired. For example, PIC 110 may include caches, modems, parallel or serial interfaces, SCSI interfaces, network interface cards, and the like.

As illustrated in FIG. 2, I/O control device 204 is coupled to I/O devices 205, such as one or more USB ports, a keyboard, a mouse, audio speakers, etc. I/O control device 204 is also coupled to non-volatile storage 207, such as a flash memory or other read only memory (ROM) 208, BIOS 210, and hard disk drive 209. PIC 110 is depicted as being connected to communication network 122 and the Internet 140 by a communication device 211, such as a modem, but the connection may be established by any desired network communication device known to those of skill in the art. Though processor 202 is shown as being coupled indirectly to display 214 the processor 202 may also be coupled directly to a display device 214.

Various programming codes and software are stored in the PIC memory. For example, the basic input/output system (BIOS) code that initiates PIC 110 at startup may be stored in a BIOS ROM device 210 of non-volatile storage 207, such as a ROM (Read Only Memory) or a PROM (Programmable ROM) such as an EPROM (Erasable PROM), an EEPROM (Electrically Erasable PROM), a flash RAM (Random Access Memory) or any other type of memory appropriate for storing BIOS. BIOS 210 includes a compatible bootloader to enable the PIC operating system to be an embedded closed operating system, such as a Windows CE type operating system, though any operating system (including but not limited to Windows-based and Linux-based Operating Systems) could be supported by the BIOS code. BIOS/Bootloader 210 is essentially invisible to the user and boots to the operating system.

PIC software 230 and user data 235 may also be stored on hard drive 209 and executed and/or processed by processor 202. PIC software 230 includes master boot record (MBR) 231, operating system 232, application program partition 233, software update module 234, user data 235, and hidden image recovery module 236. The MBR 231 is the first sector (512 bytes long) on the hard drive 209. This sector contains bootstrap code and a partition table. The bootstrap code is executed when PIC 110 boots up. As for the operating system, several uniquely configurable operating parameters that can affect the performance of the system are pre-configured as part of software 230 when it is initially installed on hard disk drive 209. Software 230 also includes application programs 233 that are needed for PIC 110 to function as specified. For example, applications 233 may include Web browser, Flash player, presentation viewer for PowerPoint, chat, game, compression utility, e-mail, word processor, spreadsheet, PDF viewer, drawing applications and/or media player supporting pop-up windows supporting graphic applications such as HTL, Flash, Shockwave, etc. In addition, user data 235 stores all of the user's data so that a user has direct access to the user data. This user data is protected from the rest of the operating system to prevent corruption of the data by a virus or other means.

In an embodiment of the invention, PIC 110 is protected against unauthorized display of content or installation of software by configuring PIC software 230 so that content files or software applications are added or updated only from boot loader devices that have a predetermined authorization or security key. An example of such a boot loader device is a USB-connected flash storage device. In an example implementation, the installation restriction is controlled by software update module 234, which only allows installations from boot devices having a key that matches a locally stored installation key, such as a unique security key 240 that is stored in non-volatile memory 207. The unique security key 240 may be unique for each

PIC 110a-n or may instead be shared among the PICa-n to collectively control installation access from a single source (e.g., ISP 120). In an embodiment of the invention, unique security key 240 is stored in master boot record 231 of hard drive 209, although it may also be stored in flash memory or other ROM 208 or on a hardwired integrated circuit. Thus, before any operating system files or application files are transferred from the bootable device, update module 234 must determine that the boot device has a signature or key that matches or otherwise corresponds to unique security key 240. In this way, unique security key 240 can be used to protect the integrity of the operating system on PIC 110 by restricting installation of operating system code or other software to bootable devices that have a matching security key.

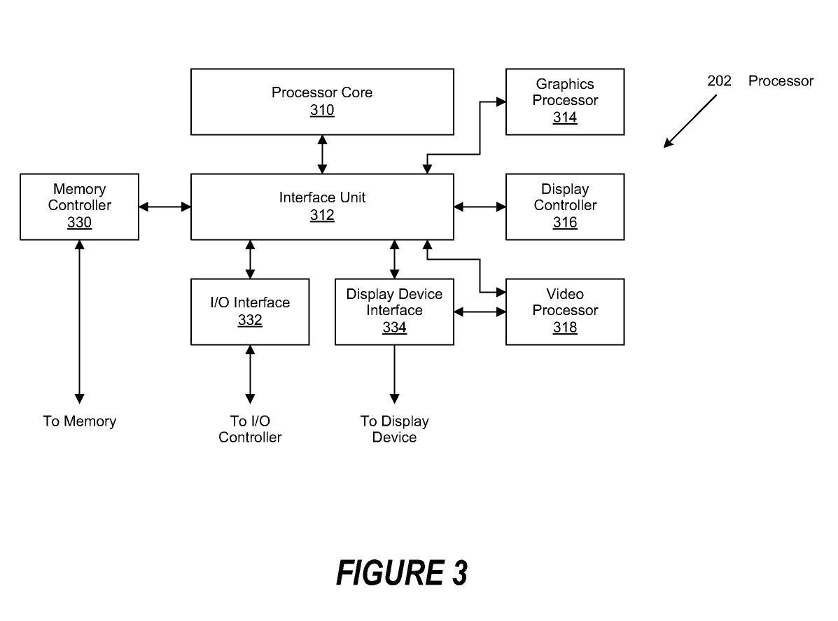

Referring to FIG. 3, a block diagram of the processor 202 is shown. In one embodiment, processor 202 is a Geode GX2 processor available from Advanced Micro Devices. Processor 202 includes a processor core 310, a bus or interface unit 312, a graphics processor 314, a display controller 316, and a video processor 318. Processor 202 also includes memory controller 330, I/O controller interface 332 and display device interface 334, though it will be appreciated that these controllers and interfaces may be implemented externally to processor 202. In the illustrated embodiment, processor 202 executes software stored in memory 206, 207 to restrict installation of operating systems and other software from boot devices that do not include an authorized signature that matches or corresponds to unique security key 240.

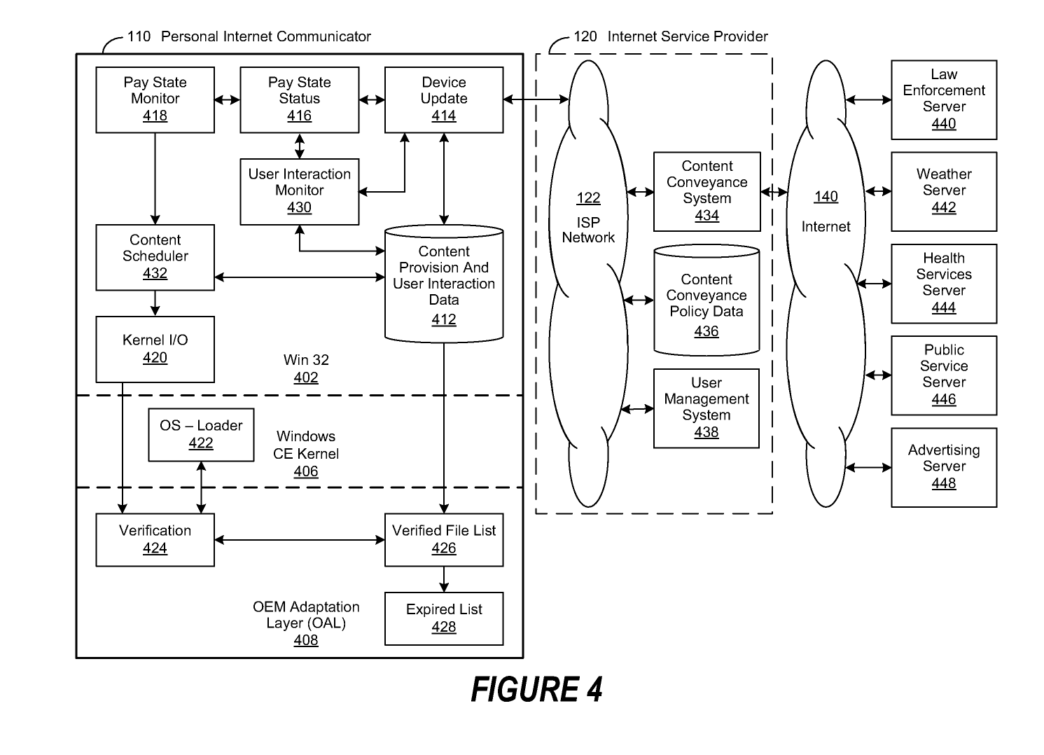

FIG. 4 is a block diagram of the functional components for implementing a persistent announcement channel through a verified computing environment of personal Internet communicator (PIC) 110 in accordance with an embodiment of the invention. In one embodiment, PIC 110 receives predetermined digital content from Internet service provider (ISP) 120, which serves as a conduit for digital content delivered through the Internet 140 from a plurality of predetermined digital content providers. Predetermined digital content providers include law enforcement server 440, weather server 442, heath services server 444, public service server 446, and advertising server 448. ISP 120 comprises content conveyance system 434, content conveyance policy database 436, user management system 438, and ISP communications network 122. Content conveyance system 434 retrieves predetermined digital content from digital content providers 440, 442, 444, 446, 448 via the Internet 140. Based on the pay state status of PIC 110 users managed by user management system 438, content conveyance system 434 then conveys predetermined digital content to the PIC 110 via ISP communications network 122. ISP communication network 122 may be comprised of a variety of connection links, including but not limited to, a wired connection, a direct link such as a digital subscriber line (DSL), T1, integrated services digital network (ISDN) or cable connection. ISP communication network 122 may also comprise a wireless connection via a cellular or satellite network, phone modem dialup access, or a local data transport system, such as Ethernet or token ring over a local area network.

The functional components shown in FIG. 4 can also be used to implement an embodiment of the invention that monitors the pay state status of each PIC user and modifies the functionality of the various software modules in PIC 110 based on the user's pay state status. The method and apparatus of the present invention can be implemented in a wide range of operating system environments. In an embodiment of the present invention, shown in FIG. 4, the software operating system environment of PIC 110 comprises three layers: Windows® “Win 32” layer 402, Windows® “CE Kernel” layer 406, and OEM Adaptation layer 408. In various embodiments, Win 32 layer 402 contains content provision and user interaction database 412, comprising digital content that can be provided to a predetermined user of PIC 110 and interaction information resulting from user interaction with provided digital content. In one embodiment, content provision and user interaction database 412 contains a list of software applications and files that are authorized for use as well as a list of software applications and files that are either expired or no longer authorized for use. Win 32 layer 402 also comprises device update module 414, pay state module 416, pay state status monitor module 418, user interaction monitor module 430, content scheduler module 432, and kernel input/output module 420.

Device update client 414 manages the receipt of predetermined digital content conveyed from content conveyance system 434 to PIC 110. Device update client 414 also manages the conveyance of user interaction information from content provision and user interaction database 412 to user management system 438. In addition, device update client 414 receives scripts to launch pay state command line parameters that include parameters for whether a user is permitted to interact with predetermined digital content. Pay state command line parameters likewise include parameters to determine whether a user is currently meeting their associates policy requirements, as contained in content conveyance policy database 436. User interaction monitor module 430 monitors the user's interaction with the PIC 110, including interaction with predetermined digital content and the execution of authorized software applications. In an embodiment of the invention, user interactions including user gestures acknowledging the receipt and viewing of predetermined digital content are recorded by user interaction monitor module 430. The recorded gestures are then provided as inputs to scripts that contain parameters (e.g., digital content interaction variables) that define a predetermined provisioning state for the PIC 110. user interaction monitor module 430 also conveys user gestures acknowledging the receipt and viewing of predetermined digital content to device update client 414. In turn, device update client 414 communicates digital content user interaction information to user management system 438, which references content conveyance policy database 436 to perform compliance comparison operations. Content conveyance system 434 reports digital content conveyance, verification of user interaction with conveyed digital content, and user compliance with content conveyance policies to content provider sources 440, 442, 444, 446, 448 through the Internet 140. In one embodiment, verification of predetermined user interactions with predetermined digital content results in revenue streams from advertising content provider source 448 to offset the cost of providing PICs 110 to underserved population segments. In another embodiment, verification of predetermined user interactions with predetermined digital content results in content provider sources 440, 442, 444 and 446 receiving verification that service announcements have been delivered and received.

Pay state status module 416 maintains the pay state status of the user and provides state change information to pay state status monitor module 418. Pay state status monitor module 418 provides pay state status information to content scheduler 432, which uses the provided pay state status information to determine the presentation of predetermined digital content. Pay state status monitor module 418 also maintains the system global state and periodically requests system state updates from device update module 414 via pay state status module 416. Pay state status monitor module 418 is also operable to use a series of timers to request updated digital content interaction state information at predetermined time intervals. Pay state status monitor module 418 can also use timers to monitor the length of time that PIC 110 is disconnected from the ISP 120. If PIC 110 is disconnected from the ISP for a prolonged period of time, pay state monitor module 418 can cause PIC 110 to reduce or eliminate the functionality of a predetermined set of software files.

Pay state status monitor module 418 is also operable to schedule the presentation of predetermined subsets of conveyed digital content via content scheduler 432 if the use of the PIC 110 is not complying with predetermined digital content conveyance policy requirements. In different embodiments of the invention, the functionality of content and software files on PIC 110 are determined by the pay state of the user, wherein pay state status monitor 418 provides operating system 402 with information concerning the pay state status of the user. In an embodiment of the invention, PIC 110 is operable to provide limited functionality of certain software packages based on a first pay state status and to offer no functionality based on a second pay state status. As an example, the PIC 110 may cease to perform predetermined operations if a user has discontinued his contractual relationship with an Internet service provider or is not complying with the requirements of the PIC's digital content conveyance policy. In one embodiment, the pay state works on a credit system. As predetermined digital content is signified by user gestures to acknowledge its presentation and subsequent interaction, pay state credits accumulate, granting the user the ability to view other predetermined digital content or use PIC 110 for other purposes. As PIC 110 is used for other purposes or for viewing other content, pay state credits deplete. If pay state credit depletes to a predetermined point, then interaction with other predetermined digital content is required before the user of the PIC 110 can continue.

When directed by pay state status monitor module 418, content scheduler 432 retrieves predetermined digital content, authorized software applications, and authorized software files from content provision and user interaction database 412. Once retrieved, they are submitted by content scheduler 432 for loading through kernel I/O 420 to verification module 424. Upon detecting a request to execute an authorized software application, OS loader 422 in Windows CE kernel 406 generates a verification request to verification module 424 in the OEM adaptation layer 408. Verification module 424 maintains information concerning the current verification state and performs state changes in accordance with information received from pay state status monitor 418. Verification file list 426 contains a list of digital content files that are authorized for display in the persistent content display area of the PIC screen and software files that are authorized for use. Upon a load request, verification module 424 checks the list of software files in verification file list 426 to determine whether the requested digital content or software file is on a list of verified files. If the requested file is found on verified file list 426, OS loader 422 will execute the requested file. If, however, the requested file is not found on verified list 428, OS loader 422 will not execute the requested file. Upon a request to load a particular predetermined digital content or software file, the verification module 424 uses the verification file list containing approved content and software files. The verification module 424 also uses the pay state status of the user to determine which digital content can be displayed and which software files can be executed. In some situations, such as a change in pay state status or update of content or software files, a previously verified file may be placed on expired list 428. Expired list 428 contains files that can be placed on verification file list 428 upon a change in the user's pay state status or adherence to the PIC 100 digital content conveyance policy in accordance with the protocols outlined hereinabove.

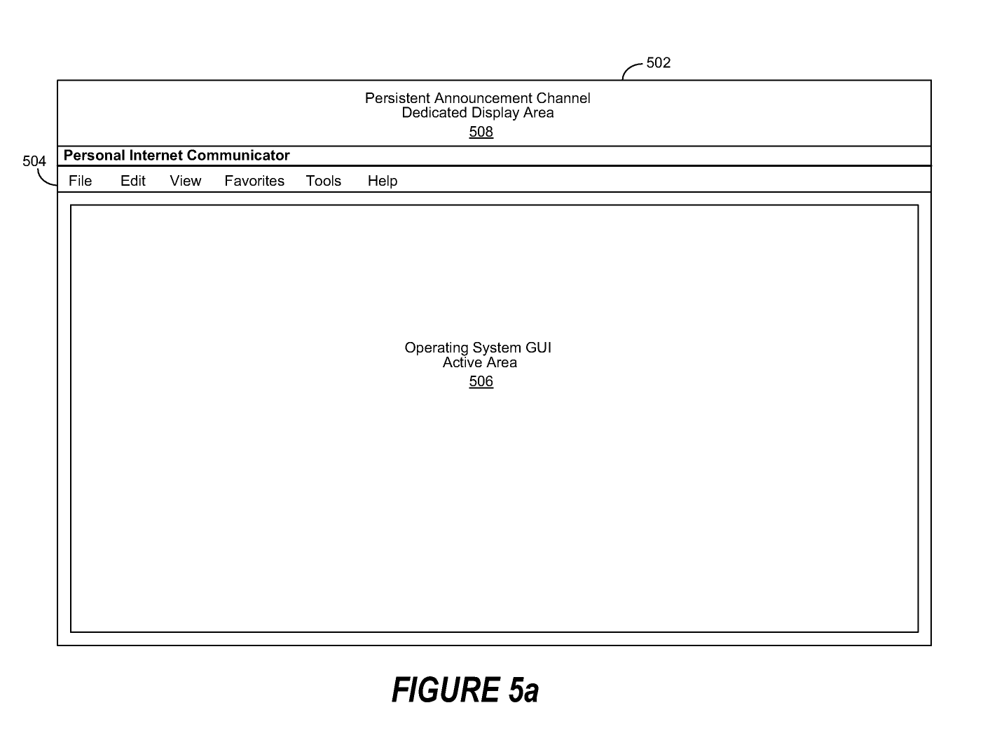

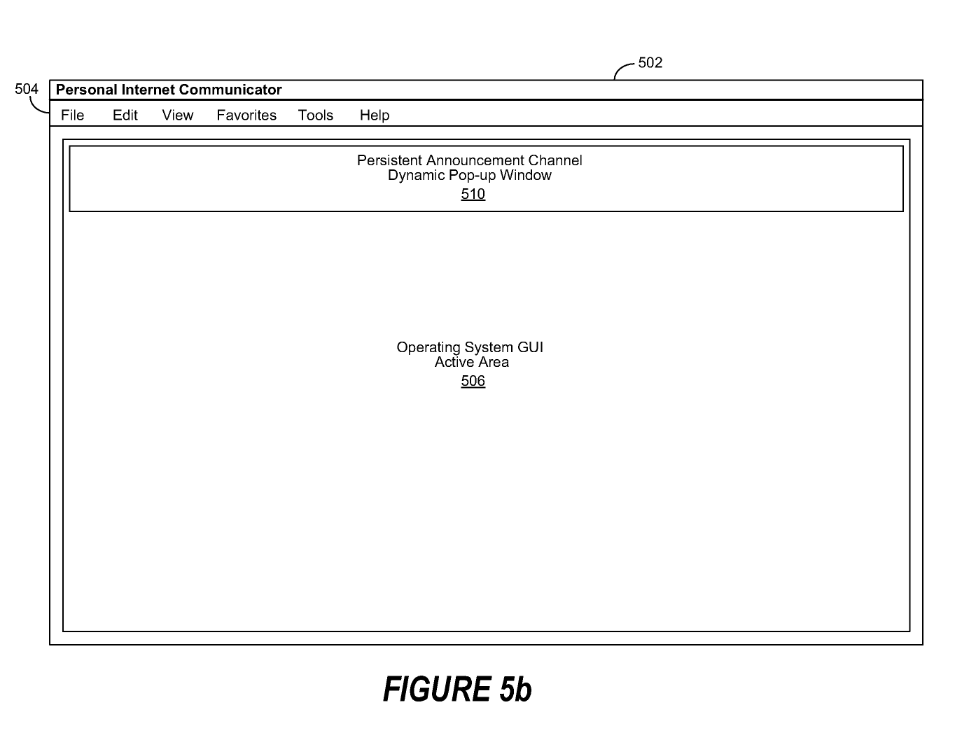

FIG. 5a is a generalized depiction of a persistent announcement delivery channel implemented as a dedicated area within a personal Internet communicator display screen 502 in accordance with an embodiment of the invention. In this embodiment of the invention, personal Internet communicator screen 502 comprises persistent announcement channel dedicated display area 508, menu bar 504, and active screen area of graphic user interface (GUI) 506 as provided by the operating system implemented on PIC 110. In this same embodiment of the invention, predetermined digital content is communicated to PIC 110 and persistently displayed in dedicated display area 508, with the amount of screen area available within PIC display screen 502 for operating system GUI active area 506 proportionately reduced. In different embodiments of the invention, predetermined digital content is displayed within persistent announcement channel dedicated display area 508 using commonly implemented graphic file formats, including but not limited to, HTML, JPEG, MPEG, AVI, WMF, Quicktime provide by Apple Computer, Inc. and Flash and Shockwave, provided by Macromedia, Inc.

The frequency and length of time that predetermined digital content is displayed within persistent announcement channel dedicated display area 508 is a result of predetermined content file attributes that are associated with the content at its time of distribution. For example, a banner message displaying the name of the ISP or government entity underwriting the cost of the PIC could be presented every time the PIC is booted. As another example, a law enforcement agency or severe weather announcement may be displayed once every ten minutes until it is superseded by a subsequent announcement, is cancelled by the issuing entity, or expires after a predetermined time interval. As yet another example, a health advisory notice may have attributes requiring its display once a day for five days, or display once every four hours until the fifteenth of the month. As a further example of an embodiment of the invention, if the PIC is in off-line use, acknowledgement that a health alert has been received can be signified by user gesture resulting in the attributes of the content being altered such that the content is not automatically displayed again, but is available for subsequent retrieval, and the sender is notified that the alert has been acknowledged as being received when the PIC is next connected to the Internet.

FIG. 5b is a generalized depiction of a persistent announcement delivery channel implemented as dynamic pop-up overlay window 510 within personal Internet communicator display screen 502 in accordance with an embodiment of the invention. In this embodiment of the invention, personal Internet communicator screen 502 comprises of persistent announcement channel dynamic pop-up window 510, menu bar 504, and active screen area of graphic user interface (GUI) 506 as provided by the operating system implemented on PIC 110. In another embodiment of the invention, predetermined digital content is displayed via the operating system implemented on PIC 110 through dynamic pop-up window 510 that overlays any currently running application, including but not limited to, a Web browser. In different embodiments of the invention, predetermined digital content is displayed within persistent announcement channel dynamic pop-up window 510 using commonly implemented graphic file formats, including but not limited to, HTML, JPEG, MPEG, AVI, WMF, Quicktime provide by Apple Computer, Inc. and Flash and Shockwave, provided by Macromedia, Inc.

The frequency and length of time that predetermined digital content is displayed within dynamic pop-up window 510 is a result of predetermined digital content file attributes that are associated with the content at its time of distribution. In this same embodiment of the invention, predetermined digital content is communicated to PIC 110 and persistently displayed in dynamic pop-up window 510. In an embodiment of the invention, dynamic pop-up window 510 displays predetermined digital content for a predetermined time interval, according to content file attributes that are associated with the content at its time of distribution, before it automatically closes. In another embodiment of the invention, dynamic pop-up window 510 displays predetermined digital content until the PIC user acknowledges through user gestures (e.g., mouse click, control key sequence, etc.) that the content has been received and viewed.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those skilled in the art. The depicted and described embodiments are examples only, and are not exhaustive of the scope of the invention. Although the present invention has been described in detail, it should be understood that various changes, substitutions and alterations can be made hereto without departing from the spirit and scope of the invention as defined by the appended claims.

What is claimed is:

1. A system for the verifiable conveyance of predetermined digital content, comprising:
a digital content conveyance system operable to retrieve predetermined digital content from a plurality of predetermined digital content providers and convey said retrieved digital content to at least one digital content receiver;
a content scheduler module operable to persistently present a first subset of said conveyed digital content for interaction by a user, said interaction with said first subset of conveyed digital content a requisite for interaction with a second subset of said conveyed digital content; and
a user interaction monitor module operable to generate verification of said interaction with said conveyed digital content by a user of said at least one digital content receiver.

2. The system of claim 1, wherein said retrieved digital content conveyed by said content conveyance system to said user is controlled by a user management system configured for compliance with a plurality of predetermined digital content conveyance policy requirements.

3. The system of claim 1, wherein said content scheduler module persistently presents said first subset of conveyed digital content according to the pay state status of said user, wherein said pay state status provided by a pay state status monitor.

4. The system of claim 3, wherein said pay state status comprises predetermined user interaction parameters and metrics.

5. The system of claim 4, wherein predetermined pay state status information is generated by a user interaction module operable to monitor and capture user interaction with said first subset of conveyed digital content.

6. The system of claim 1, wherein:
said user interaction verification is conveyed to a user management system;
said user management system performs compliance comparison operations between said predetermined user interaction verification and a plurality of predetermined digital content conveyance policy requirements; and
the results of said compliance comparison operations are conveyed to said plurality of digital content providers by said digital content conveyance system.

7. A computer-implementable method for the verifiable conveyance of digital content, comprising:
retrieving predetermined digital content from a plurality of digital content providers, wherein said retrieval of predetermined digital content is managed by a digital content conveyance system;
conveying said retrieved digital content to at least one digital content receiver, said conveyance of retrieved digital content managed by said digital content conveyance system;
receiving user inputs comprising interaction with said conveyed digital content, wherein:
a first subset of said conveyed digital content is persistently presented for interaction by a content scheduler module; and
interaction with said first subset of conveyed digital content is a requisite for interaction with a second subset of said conveyed digital content; and
verifying interaction with said conveyed digital content by at least one user of said at least one digital content receiver, wherein said predetermined user interaction verification is generated by a user interaction monitor module.

8. The method of claim 7, wherein said retrieved digital content conveyed by said content conveyance system to said user is controlled by a user management system operable to be configured for compliance with a plurality of predetermined digital content conveyance policy requirements.

9. The method of claim 7, wherein said content scheduler module persistently presents said first subset of conveyed digital content according to the pay state status of said user, wherein said pay state status provided by a pay state status monitor.

10. The method of claim 9, wherein said pay state status comprises predetermined user interaction parameters and metrics.

11. The method of claim 10, wherein said predetermined pay state status information is generated by a user interaction module operable to monitor and capture user interaction with said first subset of conveyed digital content.

12. The method of claim 7, wherein:
said user interaction verification is conveyed to a user management system;
said user management system performs compliance comparison operations between said predetermined user interaction verification and a plurality of predetermined digital content conveyance policy requirements; and
the results of said compliance comparison operations are conveyed to said plurality of digital content providers by said digital content conveyance system.

13. A computer-implementable business method for the verifiable conveyance of digital content, comprising:
retrieving predetermined digital content from a plurality of digital content providers, wherein said retrieval of predetermined digital content is managed by a digital content conveyance system;
conveying said retrieved digital content to at least one digital content receiver, said conveyance of retrieved digital content managed by said digital content conveyance system;
receiving user inputs comprising interaction with said conveyed digital content, wherein:
a first subset of said conveyed digital content is persistently presented for interaction by a content scheduler module; and
interaction with said first subset of conveyed digital content is a requisite for interaction with a second subset of said conveyed digital content; and
verifying interaction with said conveyed digital content by at least one user of said at least one digital content receiver, wherein said predetermined user interaction verification is generated by a user interaction monitor module.

14. The business method of claim 13, wherein said retrieved digital content conveyed by said content conveyance system to said user is controlled by a user management system configured for compliance with a plurality of predetermined digital content conveyance policy requirements.

15. The business method of claim 13, wherein said content scheduler module persistently presents said first subset of conveyed digital content according to the pay state status of said user, wherein said pay state status provided by a pay state status monitor.

16. The business method of claim 15, wherein said pay state status comprises predetermined user interaction parameters and metrics.

17. The business method of claim 16, wherein predetermined pay state status information is generated by a user interaction module operable to monitor and capture user interaction with said first subset of conveyed digital content.

18. The business method of claim 13, wherein:
said user interaction verification is conveyed to a user management system;
said user management system performs compliance comparison operations between said predetermined user interaction verification and a plurality of predetermined digital content conveyance policy requirements; and
the results of said compliance comparison operations are conveyed to said plurality of digital content providers by said digital content conveyance system.

19. The business method of claim 13, wherein said plurality of providers of predetermined digital content provide cost subsidies for the provision of said at least one predetermined digital content receiver to at least one predetermined user in exchange for said verification of said predetermined user interaction with said conveyed digital content.

20. The business method of claim 19, wherein said plurality of providers of predetermined digital content discontinue cost subsidies for the provision of said at least one predetermined digital content receiver to at least one predetermined user if said predetermined user interaction with said conveyed digital content fails to comply with a plurality of predetermined digital content conveyance policy requirements.
